(19) United States
(12) Patent Application Publication
(10) Pub. No.: US 2018/0042701 A1
(43) Pub. Date: Feb. 15, 2018

(54) TRACTION DEVICE FOR CLEAR ALIGNER, CLEAR ALIGNER AND MANUFACTURING METHOD THEREOF

(71) Applicant: eClear International Co., Ltd., Los Angeles, CA (US)

(72) Inventor: TAEWEON KIM, Seoul (KR)

(21) Appl. No.: 15/233,973

(22) Filed: Aug. 11, 2016

(51) Int. Cl. A61C 7/36; A61C 7/04; A61C 7/08

(52) U.S. Cl. CPC A61C 7/36; A61C 7/08; A61C 7/04

(57) ABSTRACT

Provided are a clear aligner traction device, clear aligners, and a manufacturing method thereof, by which an orthodontic force may be increased by hanging an elastic belt on the clear aligners in a case when teeth are excessively misaligned and thus incapable of being appropriately aligned using only the clear aligners. The clear aligner traction device may include a button that is integrally formed with a clear aligner body and includes a head having a relatively large width, a neck connected to the head and having a relatively small width, and a connector for connecting the neck to the clear aligner body, and a reinforcer bonded to the button in a shape corresponding to the button to reinforce the strength of the button, such that an elastic member is hooked over the button.

### BACKGROUND

### 1. Field

The present invention relates to a clear aligner traction device, clear aligners, and a manufacturing method thereof and, more particularly, to a clear aligner traction device, clear aligners, and a manufacturing method thereof, by which an orthodontic force may be increased by hanging an elastic belt on the clear aligners in a case when teeth are excessively misaligned and thus appropriate teeth alignment is not easily achievable using only the clear aligners.

### 2. Description of the Related Art

Orthodontic treatment may be classified into metal-brace treatment using metal braces, lingual treatment using lingual braces, and clear-aligner treatment using clear aligners.

In particular, clear-aligner treatment attracts people's attention compared to the other orthodontic treatment methods because a transparent clear aligner covering teeth like a mouth piece is invisible, detachable, and easily wearable.

Clear aligners are manufactured for multiple stages in consideration of the distances and directions of moving teeth to be aligned. If the clear aligners of each stage are worn for a period of time, the teeth move to positions corresponding to the shape of the clear aligners. As such, orthodontic treatment is completed after the clear aligners of the final stage are worn.

However, if the teeth are excessively misaligned or a certain tooth seriously protrudes and thus appropriate teeth alignment is not easily achievable using only the clear aligners, the clear aligners should be used together with another orthodontic treatment method. In addition, the clear aligners are capable of moving the teeth only by small distances and thus should be worn for a long period of time.

A clear aligner traction device capable of ensuring an additional orthodontic force by thermoforming buttons on parts of clear aligners using pliers and hanging an elastic belt around the buttons is disclosed in KR 10-1109114 and used popularly.

However, in the above-described clear aligner traction device, since an elastic force and an additional traction force of the elastic belt are focused on the buttons, the buttons may be easily damaged to lose the traction force, or may be deformed or distorted due to long-term use to reduce accuracy in orthodontic treatment. Furthermore, the damaged or deformed parts may irritate an orthodontic patient to greatly reduce wearability or reliability.

### SUMMARY

The present invention provides a clear aligner traction device, clear aligners, and a manufacturing method thereof, by which buttons may be firmly reinforced using reinforcers to prevent damage or deformation of the buttons and thus to improve accuracy, wearability, and reliability in orthodontic treatment using clear aligners, an elastic belt having a greater traction force may be applied to greatly improve product performance, a reinforcement process may be simplified to improve productivity, and parts not used to produce the clear aligners may be reused for reinforcer base elements to reduce product costs. However, the scope of the present invention is not limited thereto.

According to an aspect of the present invention, there is provided a clear aligner traction device including a button that is integrally formed with a clear aligner body and includes a head having a relatively large width, a neck connected to the head and having a relatively small width, and a connector for connecting the neck to the clear aligner body, such that an elastic member is hooked over the button; and a reinforcer bonded to the button in a shape corresponding to the button to reinforce the strength of the button.

The reinforcer may include a head internal surface counterpart that corresponds to an internal surface of the head of the button; a neck internal surface counterpart that corresponds to an internal surface of the neck of the button; and a connector internal surface counterpart that corresponds to an internal surface of the connector of the button.

The reinforcer may include a head external surface counterpart that corresponds to an external surface of the head of the button; a neck external surface counterpart that corresponds to an external surface of the neck of the button; and a connector external surface counterpart that corresponds to an external surface of the connector of the button.

The button may be produced using a clear aligner base element made of a first material, having a first thickness, and provided in a panel shape, and the reinforcer may be produced using a reinforcer base element made of a second material, having a second thickness, and provided in a panel shape.

The first material and the second material may be the same in such a manner that the button and the reinforcer are overlapped and simultaneously thermoformed.

The reinforcer base element may include at least one selected among a circular panel, an oval panel, a streamlined panel, a polygonal panel, and an apple-shaped panel, which have sizes greater than an external diameter of the connector of the button.

A hole for accommodating a part of the reinforcer therein may be provided in the connector of the button.

According to another aspect of the present invention, there is provided a clear aligner including a clear aligner body; a button that is integrally formed with the clear aligner body and includes a head having a relatively large width, a neck connected to the head and having a relatively small width, and a connector for connecting the neck to the clear aligner body, such that an elastic member is hooked over the button; and a reinforcer bonded to the button in a shape corresponding to the button to reinforce the strength of the button.

According to another aspect of the present invention, there is provided a method of manufacturing a clear aligner traction device, the method including preparing a reinforcer base element, bonding the reinforcer base element to a target portion of a teeth model, compressing a heated clear aligner base element onto the teeth model having bonded the reinforcer base element thereto, at positive pressure or vacuum pressure to overlap the reinforcer base element on an internal surface of a clear aligner body, and thermoforming a head and a neck of a button by pressing the overlapped part using heated pliers.

The bonding of the reinforcer base element to the target portion of the teeth model may include coating an adhesive for temporary adhesion on the target portion of the teeth model, and attaching the reinforcer base element to the target portion.

The thermoforming of the head and the neck of the button by pressing the overlapped part using the heated pliers may include primarily thermoforming the head by pressing the overlapped part using heated pliers for forming the head, and secondarily thermoforming the neck by pressing a part of the head using heated pliers for forming the neck.

According to another aspect of the present invention, there is provided a method of manufacturing a clear aligner traction device, the method including preparing a clear aligner body, preparing a reinforcer base element, overlapping the reinforcer base element on an internal surface or an external surface of the clear aligner body, and thermoforming a head and a neck of a button by pressing the overlapped part using heated pliers.

### BRIEF DESCRIPTION OF THE DRAWINGS

The above and other features and advantages of the present invention will become more apparent by describing in detail embodiments thereof with reference to the attached drawings in which:

FIG. 1 is a perspective view of a clear aligner traction device and clear aligners according to some embodiments of the present invention;

FIG. 2 is an enlarged cross-sectional view of the clear aligner traction device of FIG. 1;

FIG. 3 is an enlarged cross-sectional view of a clear aligner traction device according to other embodiments of the present invention;

FIG. 4 is an enlarged cross-sectional view of a clear aligner traction device according to other embodiments of the present invention;

FIG. 5 is a perspective view of an example of a reinforcer base element used to manufacture the clear aligner traction device of FIG. 1;

FIG. 6 is a perspective view of another example of the reinforcer base element of FIG. 5;

FIG. 7 is a diagram for describing a process of manufacturing the clear aligner traction device according to other embodiments of the present invention;

FIG. 8 is a diagram for describing a process of manufacturing the clear aligner traction device according to other embodiments of the present invention;

FIG. 9 is a diagram for describing a process of manufacturing the clear aligner traction device according to other embodiments of the present invention;

FIG. 10 is a diagram for describing a process of manufacturing the clear aligner traction device according to other embodiments of the present invention;

FIG. 11 is a diagram for describing a process of manufacturing the clear aligner traction device according to other embodiments of the present invention;

FIG. 12 is a diagram for describing a process of manufacturing the clear aligner traction device according to other embodiments of the present invention;

FIG. 13 is a diagram for describing a process of manufacturing the clear aligner traction device according to other embodiments of the present invention;

FIG. 14 is a flowchart of a clear aligner traction device manufacturing method according to some embodiments of the present invention;

FIG. 15 is a diagram for describing a process of manufacturing the clear aligner traction device according to some embodiments of the present invention;

FIG. 16 is a diagram for describing a process of manufacturing the clear aligner traction device according to some embodiments of the present invention;

FIG. 17 is a diagram for describing a process of manufacturing the clear aligner traction device according to some embodiments of the present invention;

FIG. 18 is a diagram for describing a process of manufacturing the clear aligner traction device according to some embodiments of the present invention; and

FIG. 19 is a flowchart of a clear aligner traction device manufacturing method according to other embodiments of the present invention.

### DETAILED DESCRIPTION

Hereinafter, the present invention will be described in detail by explaining embodiments of the invention with reference to the attached drawings.

The invention may, however, be embodied in many different forms and should not be construed as being limited to the embodiments set forth herein; rather, these embodiments are provided so that this disclosure will be thorough and complete, and will fully convey the concept of the invention to one of ordinary skill in the art. In the drawings, the thicknesses or sizes of layers are exaggerated for clarity.

The terminology used herein is for the purpose of describing particular embodiments only and is not intended to be limiting of embodiments. As used herein, the singular forms “a,” “an” and “the” are intended to include the plural forms as well, unless the context clearly indicates otherwise. It will be further understood that the terms “comprises” and/or “comprising” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to schematic illustrations of idealized embodiments (and intermediate structures) of the invention. As such, variations from the shapes of the illustrations as a result, for example, of manufacturing techniques and/or tolerances, are to be expected. Thus, the embodiments of the invention should not be construed as limited to the particular shapes of regions illustrated herein, but are to include deviations in shapes that result, for example, from manufacturing.

A clear aligner traction device, clear aligners, and a manufacturing method thereof, according to some embodiments of the present invention are now described in detail with reference to the attached drawings.

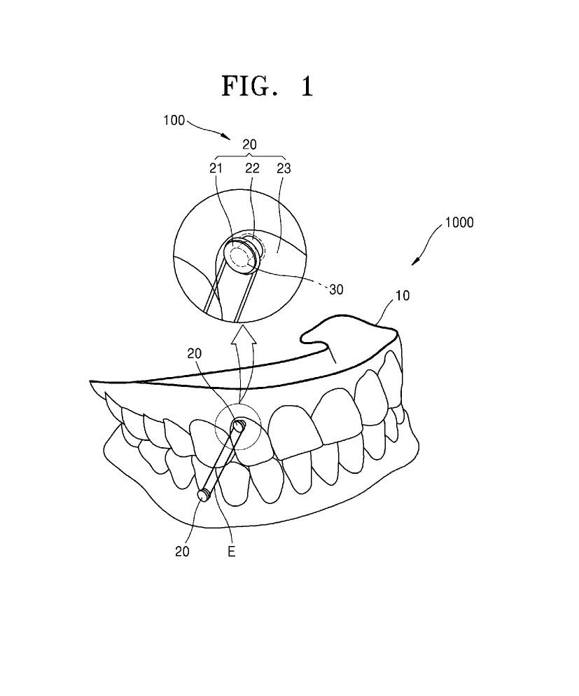

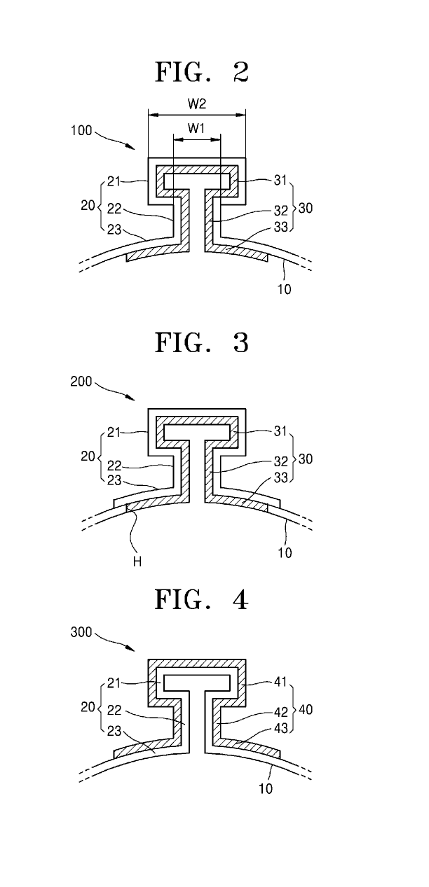

FIG. 1 is a perspective view of a clear aligner traction device 100 and clear aligners 1000 according to some embodiments of the present invention, and FIG. 2 is an enlarged cross-sectional view of the clear aligner traction device 100 of FIG. 1.

Initially, as illustrated in FIGS. 1 and 2, the clear aligner traction device 100 according to some embodiments of the present invention may include a button 20 and a reinforcer 30.

For example, as illustrated in FIGS. 1 and 2, the button 20 may be a thermoformed structure that is formed integrally with a clear aligner body 10. The button 20 includes a head 21 having a relatively large width W2, a neck 22 that is connected to the head 21 and has a relatively small width W1, and a connector 23 for connecting the neck 22 to the clear aligner body 10, such that an elastic member E such as an elastic belt is hooked over the button 20.

In addition, for example, as illustrated in FIGS. 1 and 2, the reinforcer 30 may be a thermoformed structure closely bonded to the button 20 in a shape corresponding to the button 20 to reinforce the strength of the button 20.

Specifically, for example, as illustrated in FIG. 2, the reinforcer 30 may include a head internal surface counterpart 31 corresponding to the internal surface of the head 21 of the button 20, a neck internal surface counterpart 32 corresponding to the internal surface of the neck 22 of the button 20, and a connector internal surface counterpart 33 corresponding to the internal surface of the connector 23 of the button 20.

Accordingly, the reinforcer 30 may be provided on the internal surface of the button 20 to increase the thickness of the button 20, to improve strength and durability of the button 20, and to prevent damage or deformation of the reinforcer 30.

In addition, the reinforcer 30 may be thermoformed simultaneously with the button 20 in an overlapping state to correspond to the internal surface of the button 20 and thus may be closely bonded and firmly fixed to the internal surface of the button 20. Furthermore, the reinforcer 30 may be provided in a bent state not to be separated from the button 20.

As illustrated in FIG. 2, the button 20 and the reinforcer 30 may be simultaneously thermoformed in an overlapping state using a tool, e.g., heated pliers.

In addition, an adhesive layer (not shown) or a melted and integrated interface may be provided between the button 20 and the reinforcer 30 to more closely bond the button 20 and the reinforcer 30 to each other.

Therefore, the button 20 may be firmly reinforced using the reinforcer 30 to prevent damage or deformation of the button 20 and thus to improve accuracy, wearability, and reliability in orthodontic treatment using the clear aligners 1000, and an elastic belt having a greater traction force may be applied to greatly improve product performance.

FIG. 3 is an enlarged cross-sectional view of a clear aligner traction device 200 according to other embodiments of the present invention.

As illustrated in FIG. 3, in the clear aligner traction device 200 according to other embodiments of the present invention, a hole H for accommodating part of the reinforcer 30 therein may be provided in the connector 23 of the button 20.

Accordingly, a lower surface of the reinforcer 30 may not protrude into the clear aligner body 10 but may be buried in the hole H, and thus a part that contacts the gums or teeth of an orthodontic patient may become flat. As such, wearability can be improved and foreign body sensation can be prevented.

FIG. 4 is an enlarged cross-sectional view of a clear aligner traction device 300 according to other embodiments of the present invention.

As illustrated in FIG. 4, a reinforcer 40 of the clear aligner traction device 300 according to other embodiments of the present invention may include a head external surface counterpart 41 that corresponds to the external surface of the head 21 of the button 20, a neck external surface counterpart 42 that corresponds to the external surface of the neck 22 of the button 20, and a connector external surface counterpart 43 that corresponds to the external surface of the connector 23 of the button 20.

Accordingly, the reinforcer 40 may be provided on the external surface of the button 20 to increase the thickness of the button 20, to improve strength and durability of the button 20, and to prevent damage or deformation of the button 20.

In addition, the reinforcer 40 may be thermoformed simultaneously with the button 20 in an overlapping state to correspond to the external surface of the button 20 and thus may be closely bonded and firmly fixed to the external surface of the button 20. Furthermore, the reinforcer 40 may be provided in a bent state not to be separated from the button 20.

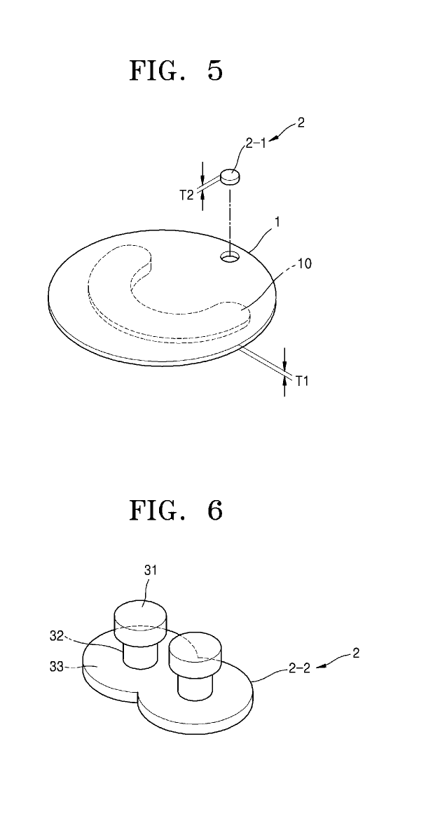

FIG. 5 is a perspective view of an example of a reinforcer base element 2 used to manufacture the clear aligner traction device 100 of FIG. 1.

As illustrated in FIG. 5, the clear aligner body 10 may be produced using a clear aligner base element 1. The button 20 may be produced using the clear aligner base element 1 made of a first material, having a first thickness T1, and provided in a panel shape. In addition, for example, the reinforcer 30 may be produced using the reinforcer base element 2 made of a second material, having a second thickness T2, and provided in a panel shape.

Accordingly, the material and thickness of the button 20 may differ from those of the reinforcer 30. For example, for wearability of the clear aligner 1000, a relatively soft and thin material may be used for the button 20 and a relatively hard and thick material may be used for the reinforcer 30, or vice versa.

However, as illustrated in FIG. 5, desirably, an unused part of the clear aligner base element 1 may be punched and reused as the reinforcer base element 2 such that the button 20 and the reinforcer 30 may be overlapped and simultaneously thermoformed at the same melting point. In this case, the first material and the second material may be the same, and the first thickness T1 and the second thickness T2 may also be the same. Therefore, a part not used to produce the clear aligner 1000 may be reused for the reinforcer base element 2 to reduce product costs.

FIG. 6 is a perspective view of another example of the reinforcer base element 2 of FIG. 5.

As illustrated in FIGS. 5 and 6, the reinforcer base element 2 may have a variety of shapes. For example, the reinforcer base element 2 may include at least one selected among a circular panel 2-1 of FIG. 5, an oval panel, a streamlined panel, polygonal panel, and an apple-shaped panel 2-2 of FIG. 6, which have sizes greater than an external diameter of the connector 23 of the button 20.

The apple-shaped panel 2-2 of FIG. 6 is usable when different traction locations are very close to each other. As illustrated in FIG. 6, two or more head internal surface counterparts 31 may be provided on the apple-shaped panel 2-2.

Meanwhile, as illustrated in FIG. 1, the clear aligners 1000 according to some embodiments of the present invention may include the clear aligner traction device 100 of the present invention. Specifically, the clear aligners 1000 may include the clear aligner body 10 an orthodontic patient wears to align his/her teeth, the button 20 that is formed integrally with the clear aligner body 10 and includes the head 21 having a relatively large width W2, the neck 22 that is connected to the head 21 and has a relatively small width W1, and the connector 23 for connecting the neck 22 to the clear aligner body 10, and the reinforcer 30 bonded to the button 20 in a shape corresponding to the button 20 to reinforce the strength of the button 20, such that an elastic member E is hooked over the button 20.

Herein, the above-described elements have the same configurations and functions as those of the clear aligner traction device 100 according to some embodiments of the present invention, and detailed descriptions thereof are not provided.

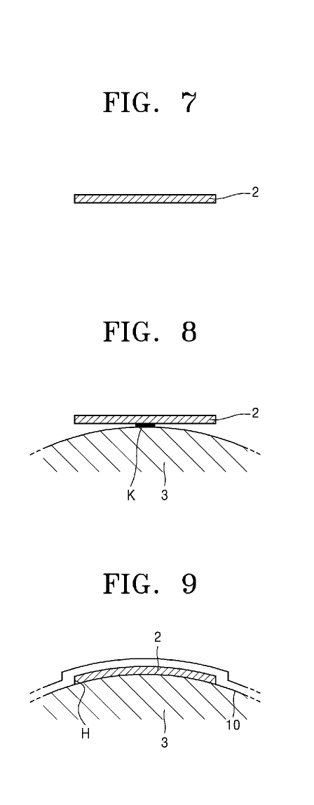

FIGS. 7 to 13 are diagrams for describing a process of manufacturing the clear aligner traction device 200 according to other embodiments of the present invention.

As illustrated in FIGS. 7 to 13, to manufacture the clear aligner traction device 200 according to other embodiments of the present invention, initially, as illustrated in FIG. 7, the reinforcer base element 2 may be prepared. Then, as illustrated in FIG. 8, the reinforcer base element 2 may be bonded to a target portion of a teeth model 3 using an adhesive K for temporary adhesion.

In this case, the adhesive K which is easily detachable may be coated on the target portion of the teeth model 3, and the reinforcer base element 2 may be attached to the target portion.

Subsequently, as illustrated in FIG. 9, the heated clear aligner base element 1 may be compressed onto the teeth model 3 having bonded the reinforcer base element 2 thereto, at positive pressure or vacuum pressure to overlap the reinforcer base element 2 on the internal surface of the clear aligner body 10.

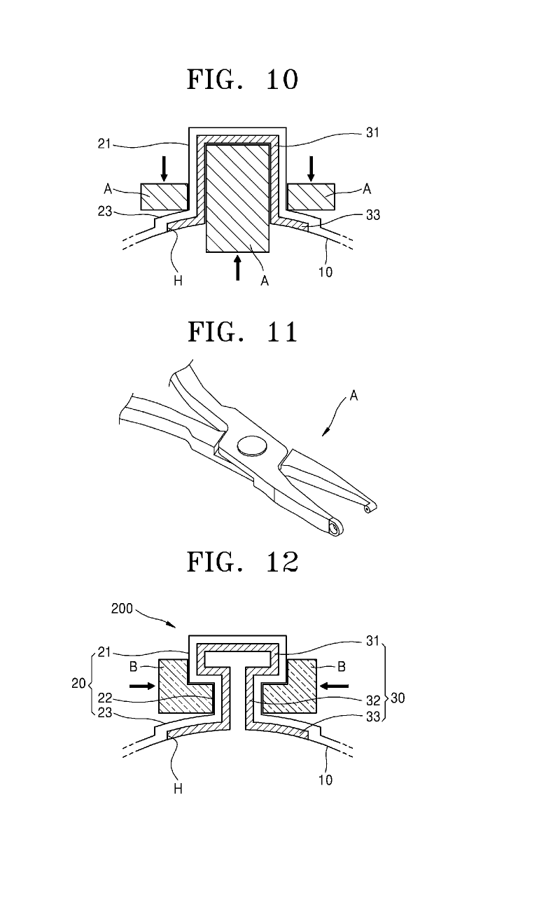

Thereafter, as illustrated in FIG. 10, the head 21 of the button 20 may be thermoformed by pressing the overlapped part using heated pliers A of FIG. 11. In this case, the reinforcer 30 may be thermoformed simultaneously with the button 20.

Then, as illustrated in FIG. 12, the neck 22 of the button 20 may be thermoformed by pressing the head 21 using heated pliers B of FIG. 13. In this case, the reinforcer 30 may be thermoformed simultaneously with the button 20.

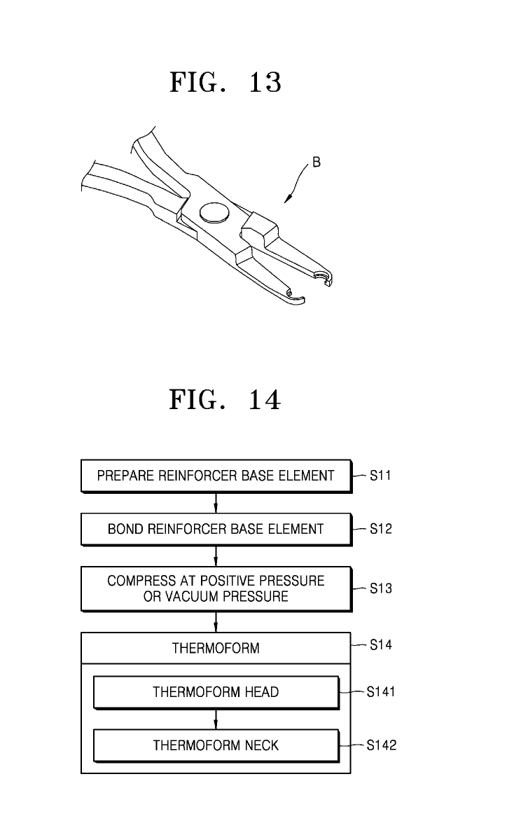

FIG. 14 is a flowchart of a clear aligner traction device manufacturing method according to some embodiments of the present invention.

As illustrated in FIGS. 1 to 14, the clear aligner traction device manufacturing method according to some embodiments of the present invention may include preparing the reinforcer base element 2 (S11), bonding the reinforcer base element 2 to a target portion of the teeth model 3 using the adhesive K for temporary adhesion (S12), compressing the heated clear aligner base element 1 onto the teeth model 3 having bonded the reinforcer base element 2 thereto, at positive pressure or vacuum pressure to overlap the reinforcer base element 2 on the internal surface of the clear aligner body 10 (S13), and thermoforming the head 21 and the neck 22 of the button 20 by pressing the overlapped part using the heated pliers A and B (S14).

Herein, the bonding of the reinforcer base element 2 to the target portion of the teeth model 3 (S12) may include coating the adhesive K on the target portion of the teeth model 3, and attaching the reinforcer base element 2 to the target portion.

In addition, the thermoforming of the head 21 and the neck 22 of the button 20 by pressing the overlapped part using the heated pliers A and B (S14) may include primarily thermoforming the head 21 by pressing the overlapped part using the heated pliers A for forming the head 21 (S141), and secondarily thermoforming the neck 22 by pressing a part of the head 21 using the heated pliers B for forming the neck 22 (S142).

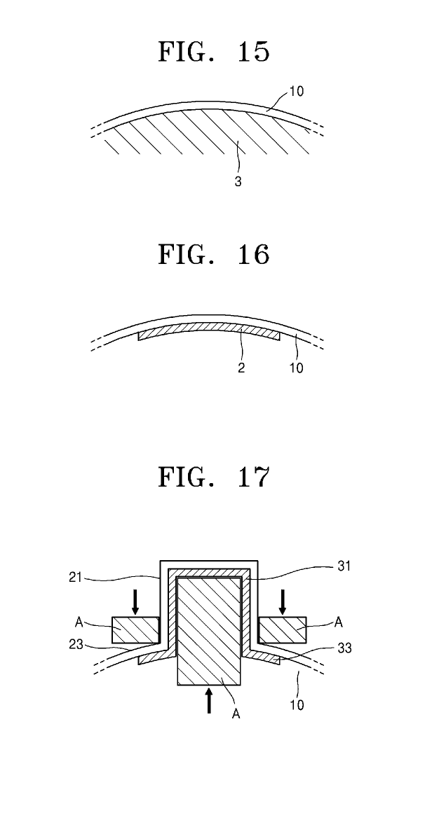

FIGS. 15 to 18 are diagrams for describing a process of manufacturing the clear aligner traction device 100 according to some embodiments of the present invention.

As illustrated in FIGS. 15 to 18, to manufacture the clear aligner traction device 100 according to some embodiments of the present invention, initially, as illustrated in FIG. 15, the clear aligner body 10 may be prepared by compressing the heated clear aligner base element 1 onto the teeth model 3 at positive pressure or vacuum pressure.

Subsequently, as illustrated in FIG. 16, the reinforcer base element 2 may be prepared and overlapped on the internal surface or the external surface of the clear aligner body 10.

Thereafter, as illustrated in FIG. 17, the head 21 of the button 20 may be thermoformed by pressing the overlapped part using the heated pliers A of FIG. 11. In this case, the reinforcer 30 may be thermoformed simultaneously with the button 20.

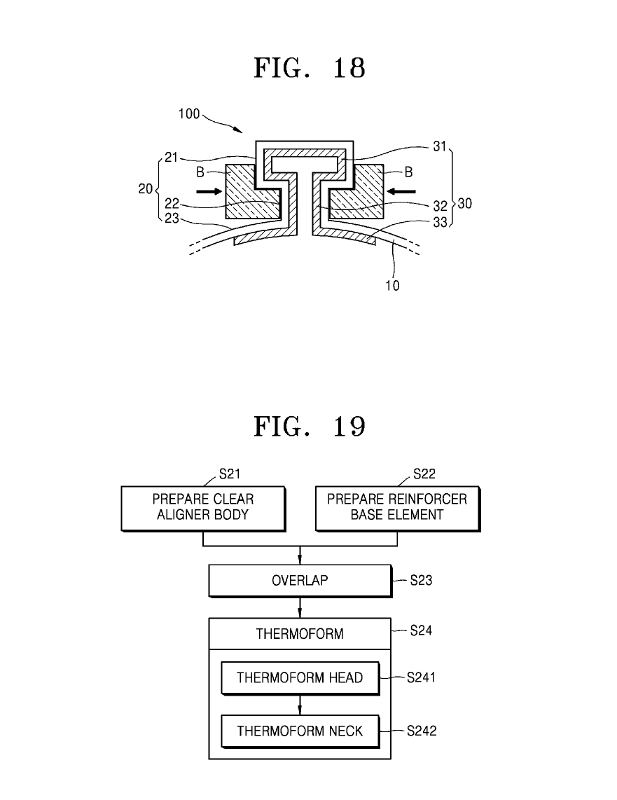

Then, as illustrated in FIG. 18, the neck 22 of the button 20 may be thermoformed by pressing the head 21 using the heated pliers B of FIG. 13. In this case, the reinforcer 30 may be thermoformed simultaneously with the button 20.

FIG. 19 is a flowchart of a clear aligner traction device manufacturing method according to other embodiments of the present invention.

As illustrated in FIGS. 1 to 19, the clear aligner traction device manufacturing method according to other embodiments of the present invention may include preparing the clear aligner body 10 (S21), preparing the reinforcer base element 2 (S22), overlapping the reinforcer base element 2 on the internal surface or the external surface of the clear aligner body 10 (S23), and thermoforming the head 21 and the neck 22 of the button 20 by pressing the overlapped part using the heated pliers A and B (S24).

Herein, as illustrated in FIG. 19, the thermoforming of the head 21 and the neck 22 of the button 20 by pressing the overlapped part using the heated pliers A and B (S24) may include primarily thermoforming the head 21 by pressing the overlapped part using the heated pliers A for forming the head 21 (S241), and secondarily thermoforming the neck 22 by pressing a part of the head 21 using the heated pliers B for forming the neck 22 (S242).

According to the above-described embodiments of the present invention, buttons may be firmly reinforced using reinforcers to prevent damage or deformation of the buttons and thus to improve accuracy, wearability, and reliability in orthodontic treatment using clear aligners, an elastic belt having a greater traction force may be applied to greatly improve product performance, a reinforcement process may be simplified to improve productivity, and parts not used to produce the clear aligners may be reused for reinforcer base elements to reduce product costs. However, the scope of the present invention is not limited to the above-described effects.

While the present invention has been particularly shown and described with reference to embodiments thereof, it will be understood by one of ordinary skill in the art that various changes in form and details may be made therein without departing from the spirit and scope of the present invention as defined by the following claims.

1. A clear aligner traction device comprising:
a button that is integrally formed with a clear aligner body and includes a head having a relatively large width, a neck connected to the head and having a relatively small width, and a connector for connecting the neck to the clear aligner body, such that an elastic member is hooked over the button; and
a reinforce disposed inside or outside the button and bonded to the button in a shape corresponding to the button to reinforce the strength of the button.

2. The device of claim 1, wherein the reinforcer is disposed inside the button and comprises:
a head internal surface counterpart that corresponds to an internal surface of the head of the button;
a neck internal surface counterpart that corresponds to an internal surface of the neck of the button; and
a connector internal surface counterpart that corresponds to an internal surface of the connector of the button.

3. The device of claim 1, wherein the reinforce is disposed outside the button and comprises:
a head external surface counterpart that corresponds to an external surface of the head of the button;
a neck external surface counterpart that corresponds to an external surface of the neck of the button; and
a connector external surface counterpart that corresponds to an external surface of the connector of the button.

4. The device of claim 1, wherein the button is produced using a clear aligner base element made of a first material, having a first thickness, and provided in a panel shape, and
wherein the reinforcer is produced using a reinforcer base element made of a second material, having a second thickness, and provided in a panel shape.

5. The device of claim 4, wherein the first material and the second material are the same in such a manner that the button and the reinforcer are overlapped and simultaneously thermoformed.

6. The device of claim 4, wherein the reinforcer base element comprises at least one selected among a circular panel, an oval panel, a streamlined panel, a polygonal panel, and an apple-shaped panel, which have sizes greater than an external diameter of the connector of the button.

7. The device of claim 1, wherein a hole for accommodating part of the reinforcer therein is provided in the connector of the button.

8. A clear aligner comprising:
a clear aligner body;
a button that is integrally formed with the clear aligner body and includes a head having a relatively large width, a neck connected to the head and having a relatively small width, and a connector for connecting the neck to the clear aligner body, such that an elastic member is hooked over the button; and
a reinforce disposed inside or outside the button and bonded to the button in a shape corresponding to the button to reinforce the strength of the button.

9. A method of manufacturing a clear aligner traction device, the method comprising:
preparing a reinforcer base element;
bonding the reinforcer base element to a target portion of a teeth model;
compressing a heated clear aligner base element onto the teeth model having bonded the reinforcer base element thereto, at positive pressure or vacuum pressure to overlap the reinforcer base element on an internal surface of a clear aligner body; and
thermoforming a head and a neck of a button by pressing the overlapped part using heated pliers.

10. The method of claim 9, wherein the bonding of the reinforcer base element to the target portion of the teeth model comprises:
coating an adhesive for temporary adhesion on the target portion of the teeth model; and
attaching the reinforcer base element to the target portion.

11. The method of claim 9, wherein the thermoforming of the head and the neck of the button by pressing the overlapped part using the heated pliers comprises:
primarily thermoforming the head by pressing the overlapped part using heated pliers for forming the head; and
secondarily thermoforming the neck by pressing a part of the head using heated pliers for forming the neck.

12. A method of manufacturing a clear aligner traction device, the method comprising:
preparing a clear aligner body;
preparing a reinforcer base element;
overlapping the reinforcer base element on an internal surface or an external surface of the clear aligner body; and
thermoforming a head and a neck of a button by pressing the overlapped part using heated pliers.
